(19) United States
(12) Patent Application Publication
(10) Pub. No.: US 2004/0177729 A1
(43) Pub. Date: Sep. 16, 2004

(54) Screw and screw driver

(76) Inventors: Jory Bell, San Francisco, CA (US); Michael Prichard, Oakland, CA (US); Jonathan Betts-LaCroix, Chatsworth, CA (US)

Correspondence Address: ROBERT PLOTKIN, ESQ, 45 BUTTERNUT CIRCLE, CONCORD, MA, 01742-1937, US

(21) Appl. No.: 10/385,133

(22) Filed: Mar. 10, 2003

(51) Int. Cl. B25B 13/48

(52) U.S. Cl. 81/176.15

(57) ABSTRACT

Various screws and corresponding screwdrivers are disclosed. For example, in one embodiment a screwdriver having a single, circular, non-axial pin is disclosed, and a corresponding screw having a single, circular, non-axial bore is disclosed. In another embodiment, a screwdriver (and corresponding screw) having a plurality of pins arranged asymmetrically about the central axis of the screwdriver is disclosed. In yet another embodiment, a screwdriver (and corresponding screw) having an irregularly-shaped and centrally-located pin is disclosed. Techniques for combining these and other features in various ways are also disclosed.

### BACKGROUND

1. Field of the Invention

The present invention relates to screws and screw drivers and, more particularly, to screws and screwdrivers of the bore and pin variety.

2. Related Art

Various kinds of screws and screw drivers are well known in the art. Referring to FIG. 1, for example, a conventional flat-head screwdriver 100 and slot-head screw 108 are shown. The screwdriver 100 includes a generally cylindrical grip 102, a cylindrical shank 104, and a flat tapered blade 106 aligned along a central axis 130. The screw 108 includes a generally flat and round head 110 at the end of a shank 114. A slot 112 bisects the surface of the head 110.

The screwdriver 100 may be grasped by the grip 102 and the blade 106 guided to engage the slot 112. Torque may then be applied, typically in a clockwise direction 118, to drive the screw 108 through a material (not shown). Threads 116 on the shank 114 of the screw 108 provide added shear for driving the screw 108.

One problem with the conventional flat-head screwdriver 100 is that the blade 106 is susceptible to slippage within the slot 112. Small amounts of slippage make it more difficult to drive the screw 108, while larger amounts of slippage may cause the blade 106 to disengage from the slot 112 entirely. After each such disengagement, the blade 106 must manually be reengaged in the slot 112, making the process of driving the screw 108 tedious and time-consuming. The problem of slippage may be mitigated by shortening the length of the slot 112, but at the cost of reducing the torque applied to the screw 108 and making it more difficult to engage the blade 106 in the slot 112. Although conventional Phillips-head screws and screwdrivers address the problem of slippage by incorporating cross-shaped slot and screwdriver heads, they present the same difficulty of initially positioning the screwdriver blade within the screw slot.

Referring to FIG. 2A, a conventional dual-pin screwdriver 200 is shown for use with a dual-bore screw 208. Like the conventional flat-head screwdriver 100, the dual-pin screwdriver 200 includes a generally cylindrical grip 202 and a cylindrical shank 204. Instead of a blade, however, the screwdriver 200 includes a pair of opposing pins 206a-b, spaced equidistant from central axis 230.

Like the flat-head screw 108, the screw 208 includes a generally flat and round head 210 at the end of a shank 214. Instead of a slot, however, the screw 208 includes a pair of opposing cylindrical bores 212a-b, spaced equidistant from central axis 230.

The screwdriver 200 may be grasped by the grip 202 and the pins 206a-b guided so that they engage bores 212a and 212b, respectively. Torque may then be applied, typically in a clockwise direction 218, to drive the screw 208 through a material (not shown). Threads 216 on the shank 214 of the screw 208 provide added shear for driving the screw 208.

Although the screwdriver 200 and screw 208 solve the problem of lateral slippage, their use requires that the two pins 206a-b be manually engaged in the two bores 212a-b. This may require significant hand-eye coordination and therefore make the process of engaging the screwdriver 200 with the screw 208 difficult.

Referring to FIG. 2B, a conventional single-pin screwdriver 250 is shown for use with a single-bore screw 258. The single-pin screwdriver 250 includes a generally cylindrical grip 252 and a cylindrical shank 254. Instead of two pins, however, the screwdriver 250 includes a single centrally-located pin 256 having a square cross-section. Although conventional screwdrivers of this variety may use shapes other than squares (such as hexagons), to apply the necessary torque the pin 256 must not be circular.

Screw 258 includes a generally flat and round head 260 at the end of a shank 264. The screw 258 includes a single bore 262 located along central axis 280.

The screwdriver 250 may be grasped by the grip 252 and the pin 256 guided so that it engages bore 262. Torque may then be applied, typically in a clockwise direction 268, to drive the screw 258 through a material (not shown). Threads 266 on the shank 264 of the screw 258 provide added shear for driving the screw 258.

Referring to FIG. 3, a conventional square-head screwdriver 300 is shown for use with a square-head screw 308. Like the conventional flat-head screwdriver 300, the square-head screwdriver 300 includes a generally cylindrical grip 302 and a cylindrical shank 304. Instead of a blade, however, the screwdriver 300 includes a hollow square head 306 forming a cavity 332 having a square cross-section. The screw 308 includes a square head 310 at the end of a shank 314.

The screwdriver 300 may be grasped by the grip 302 and the screwdriver head 306 guided so that it engages the screw head 310. Torque may then be applied, typically in a clockwise direction 318, to drive the screw 308 through a material (not shown). Threads 316 on the shank 314 of the screw 308 provide added shear for driving the screw 308. The heads 306 and 310 may be polygonal shapes other than squares, such as hexagons.

Although the screwdriver 300 and screw 308 are easier to engage and are less prone to slippage than the screwdrivers 100 and 200 and screws 108 and 208 illustrated in FIGS. 1 and 2, respectively, the square head 310 of the screw 308, when exposed on the surface into which the screw 308 has been driven, may present a facade that is less aesthetically pleasing than the circular face of the flat-head screw 108. Screws having circular faces, however, require slots (as in the case of the slot 112 in the flat-head screw 108), dual and symmetrical opposing bores (as in the case of the bores 212a-b in the screw 208), or a central but non-circular bore (as in the case of the bore 262 in the screw 258) to apply the techniques of the prior art. Screws having such features have the disadvantages described above.

What is needed, therefore, is a combination of screw and screwdriver which are easily engaged with each other, not prone to slippage, and which result in an aesthetically pleasing exposed screw face.

### SUMMARY

Various screws and corresponding screwdrivers are disclosed. For example, in one embodiment a screwdriver having a single, circular, non-axial pin is disclosed, and a corresponding screw having a single, circular, non-axial bore is disclosed. In another embodiment, a screwdriver (and corresponding screw) having a plurality of pins arranged asymmetrically about the central axis of the screwdriver is disclosed. In yet another embodiment, a screwdriver (and corresponding screw) having an irregularly-shaped and centrally-located pin is disclosed. Techniques for combining these and other features in various ways are also disclosed.

One aspect of the present invention features a screw that includes a threaded shank having a lengthwise central axis and a head coupled to one end of the shank. The head includes a forward surface and a single bore. The single bore defines a region forming a gap in the forward surface. The centroid of the region is located a non-zero distance from the central axis. The bore may, for example, be circular. Another aspect of the present invention features a screwdriver for driving the screw just described. The screwdriver includes a grip, a shank coupled at one end to the grip and having a first lengthwise central axis, and a single pin coupled to the other end of the shank and having a second lengthwise central axis, wherein the first and second lengthwise central axes are not coincident. The screwdriver may include a head coupled at a first end to the other end of the shank and at a second end to the single pin. The head may include a guide-skirt having an inner surface defining a depression in the head, and the single pin may extend outward from the depression.

Another aspect of the present invention features a screw including a threaded shank having a lengthwise central axis and a head coupled to one end of the shank. The head includes a forward surface and at least two bores, which may be circular, non-circular, or a combination thereof. The at least two bores define at least two regions forming at least two gaps in the forward surface. The centroids of the at least two regions are located asymmetrically about the central axis. In another aspect of the present invention, a screwdriver is provided which includes pins appropriately shaped and arranged to engage the bores of the screw just described.

Another aspect of the present invention features a screw including a threaded shank having a lengthwise central axis and a head coupled to one end of the shank. The head includes a forward surface and at least one bore. The at least one bore defines at least one region forming at least one gap in the forward surface. The at least one region has an outline (such as a letter of the alphabet) that is not a regular polygon. In another aspect of the present invention, a screwdriver is provided which includes one or more pins appropriately shaped and arranged to engage the one or more bores of the screw just described.

Another aspect of the present invention features a screw including a threaded shank having a lengthwise central axis and a head coupled to one end of the shank. The head includes a forward surface and at least three bores. The at least three bores define at least three regions forming at least three gaps in the forward surface. The centroids of the at least three regions are located symmetrically about the central axis. In another aspect of the present invention, a screwdriver is provided which includes pins appropriately shaped and arranged to engage the bores of the screw just described.

Other features and advantages of various aspects and embodiments of the present invention will become apparent from the following description and from the claims.

### BRIEF DESCRIPTION OF THE DRAWINGS

FIG. 1 is a perspective view of a prior art flat-head screwdriver and screw;

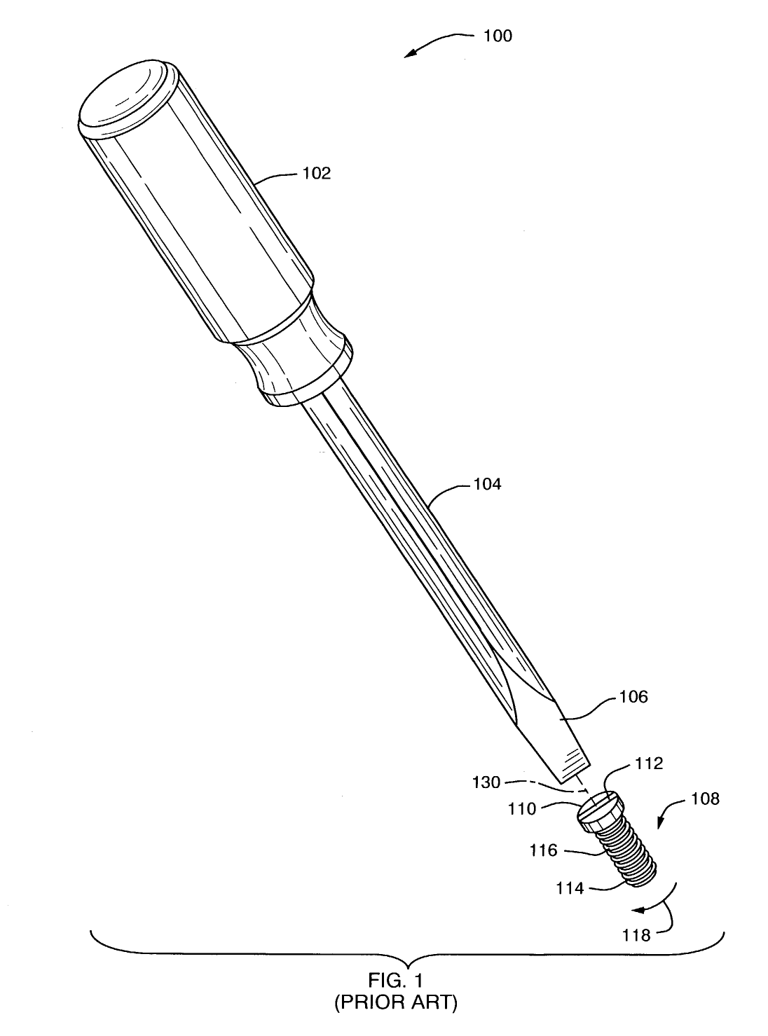

FIG. 2A is a perspective view of a prior art dual-pin screwdriver and screw;

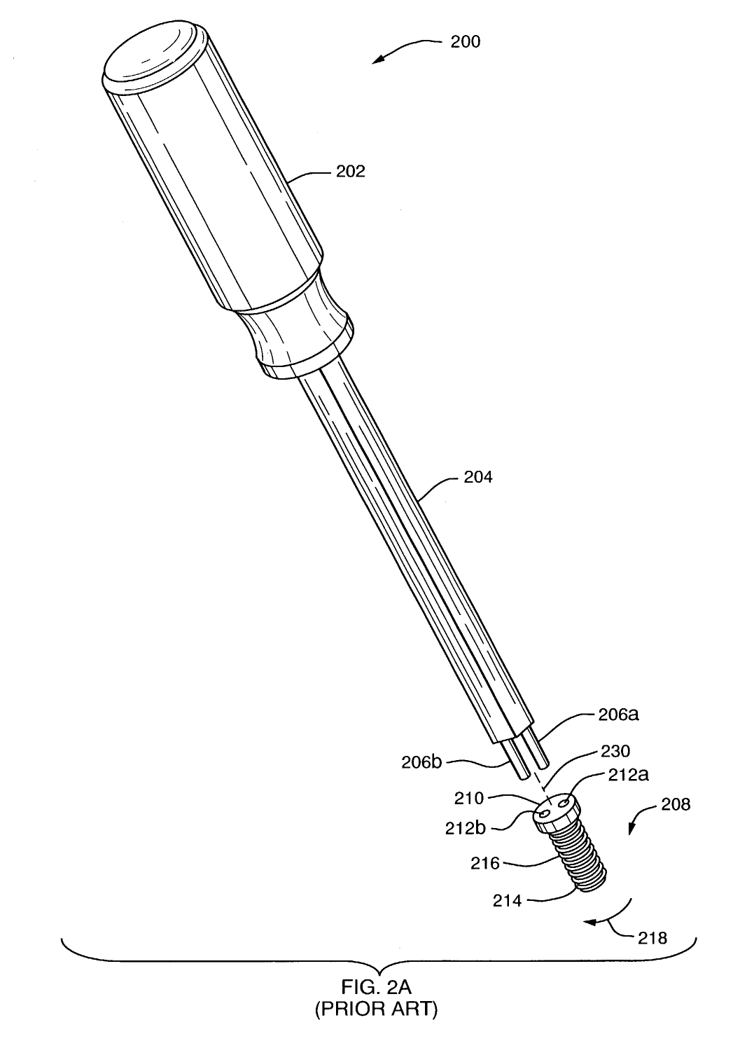

FIG. 2B is a perspective view of a prior art single-pin screwdriver and screw;

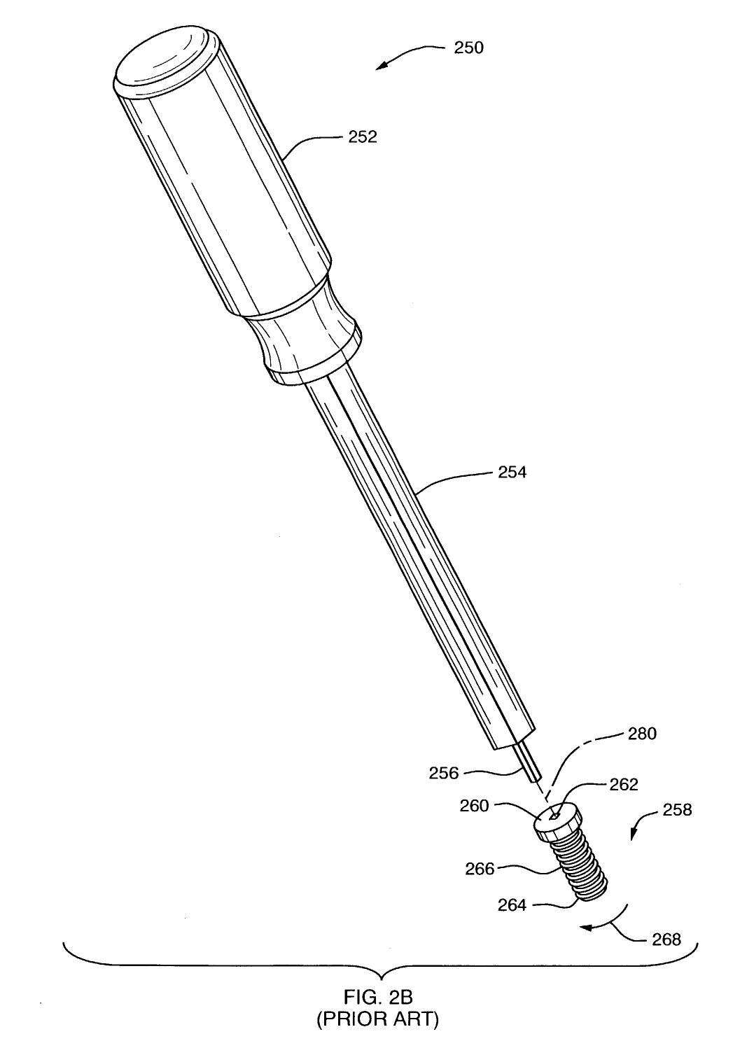

FIG. 3 is a perspective view of a prior art square-head screwdriver and screw;

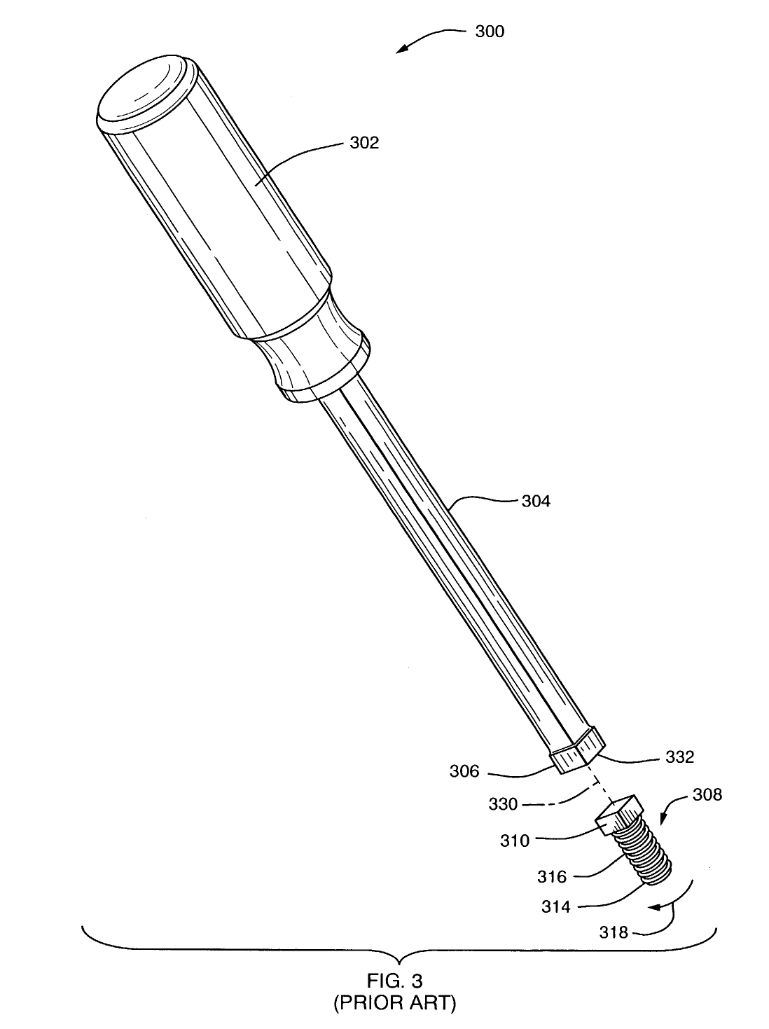

FIG. 4 is a perspective view of a single-pin screwdriver according to a first embodiment of the present invention;

FIG. 5 is a perspective view of a single-bore screw for use with the screwdriver of FIG. 4 according to the first embodiment of the present invention;

FIG. 6 is a perspective view of the screwdriver of FIG. 4 in engagement with the screw of FIG. 5 according to the first embodiment of the present invention;

FIG. 7 is a perspective view of a single-pin screwdriver according to a second embodiment of the present invention;

FIG. 8 is a perspective view of a single-bore screw for use with the screwdriver of FIG. 4 according to the second embodiment of the present invention;

FIG. 9 is a perspective view of the screwdriver of FIG. 4 in engagement with the screw of FIG. 5 according to the second embodiment of the present invention;

FIG. 10 is a perspective view of a single-pin screwdriver according to a third embodiment of the present invention;

FIG. 11 is a perspective view of a single-bore screw for use with the screwdriver of FIG. 10 according to the third embodiment of the present invention; and

FIG. 12 is a perspective view of the screwdriver of FIG. 10 in engagement with the screw of FIG. 11 according to the second embodiment of the present invention.

### DETAILED DESCRIPTION

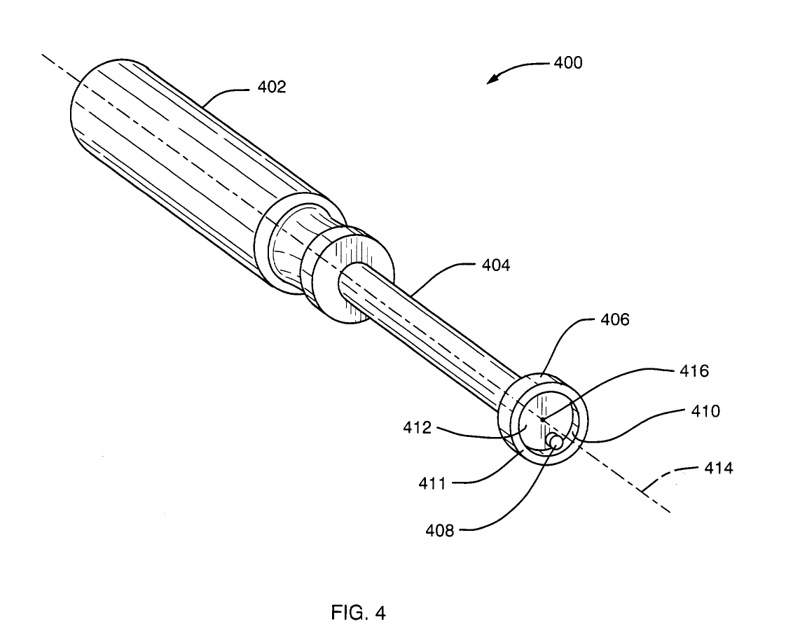

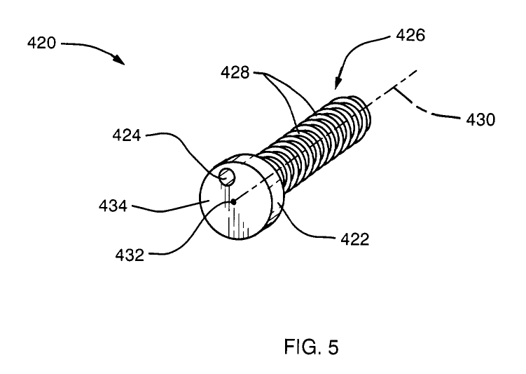

Referring to FIG. 4, a single-pin screwdriver 400 is shown according to one embodiment of the present invention. The screwdriver 400 includes a generally cylindrical grip 402, a cylindrical shank 404, and a head 406. A guide-skirt 411 on the head 406 has an inner surface 410 which defines a depression for engaging a corresponding screw (see FIG. 5, below). Central axis 414 intersects surface 412 at the center 416 of surface 412. A single non-axial pin 408 extends from forward surface 412 of head 406. Pin 408 is offset from center 416 by a distance which may be freely chosen.

Referring to FIG. 5., a single-bore screw 420 is shown for use with the screwdriver 400 according to one embodiment of the present invention. The screw 420 includes a generally flat and round head 422 at the end of a shank 426. The screw 420 includes a single cylindrical bore 424 extending into the head 422 from forward surface 434 of head 422. Central axis 430 intersects surface 434 at the center 432 of surface 434. Bore 424 is offset from center 432 by a distance which is equal to the distance of pin 408 from the center 416 of the forward surface 412 of the screwdriver 400 (FIG. 4). Bore 424 may or may not penetrate through the full depth of head 422, may or may not overlap in whole or in part with the shank 426, and may or may not penetrate into the shank 426.

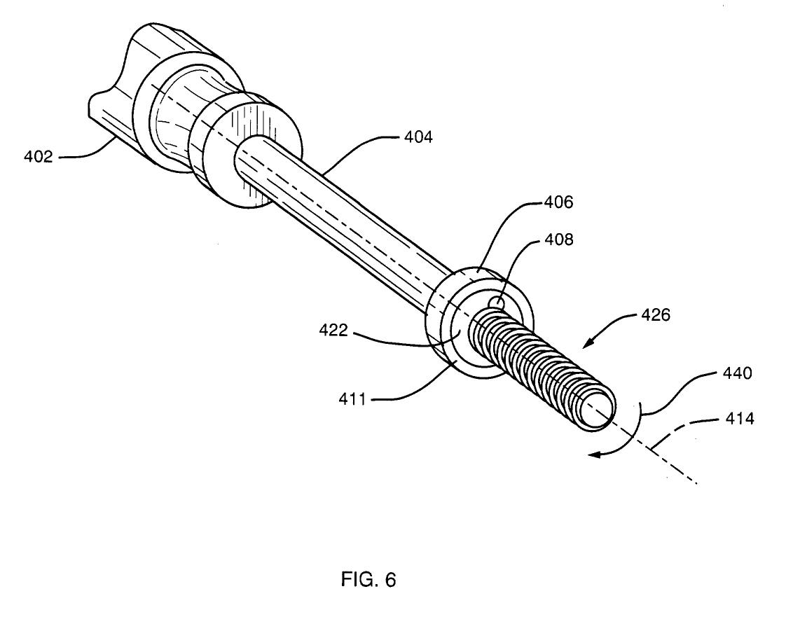

Referring to FIG. 6, the screwdriver 400 of FIG. 4 is shown in engagement with the screw 420 of FIG. 5 according to one embodiment of the present invention. The screwdriver 400 may be grasped by the grip 402 and the head 406 guided so that the pin 408 engages the bore 424 and so that the screw head 422 engages the depression in the screwdriver head 406. The inner diameter of the guide-skirt 411 is equal to or slightly larger than the diameter of the screw head 422.

Torque may then be applied to the grip 402, typically in a clockwise direction 440 about central axis 414. Torque is transferred through the pin 408 to the inner surface of bore 424, thereby causing the screw 420 to rotate and be driven through a material (not shown). Threads 428 on the shank 426 of the screw 420 provide added shear for driving the screw 420. Engagement of the screw head 422 in the guide-skirt 411 prevents lateral slippage of the screw 420 while it is being driven.

The limits of the torque applied by the screwdriver 400 derive from materials strengths and dimensions. In particular, the shear strength of the pin or bore materials must be matched to the forces applied. If the width of the screwdriver skirt 1011 is minimized in order to allow close spacing between screw heads and mechanical obstacles, then the strength of the skirt 1011 must be carefully accounted for as well. In general, the pin and skirt materials should be harder than the bore material since the screwdriver 400 is typically used to drive many screws and therefore must be more durable than the bore material against both wear and accidental breakage. The shear forces on the pin 408 and bore 424 are directly proportional to the torque applied divided by the distance from the bore 424 and pin 408 to the central axis 1014. Thus, given constant constraints on materials, designs in which the bore 424 and pin 408 are farther from the central axis 1014 will allow greater torque to be applied to driving the screw 420. Shear strength of the pin 408 and bore 424 also increase with increasing cross-sectional area. Therefore, larger-diameter pins and bores will allow greater torques to be applied.

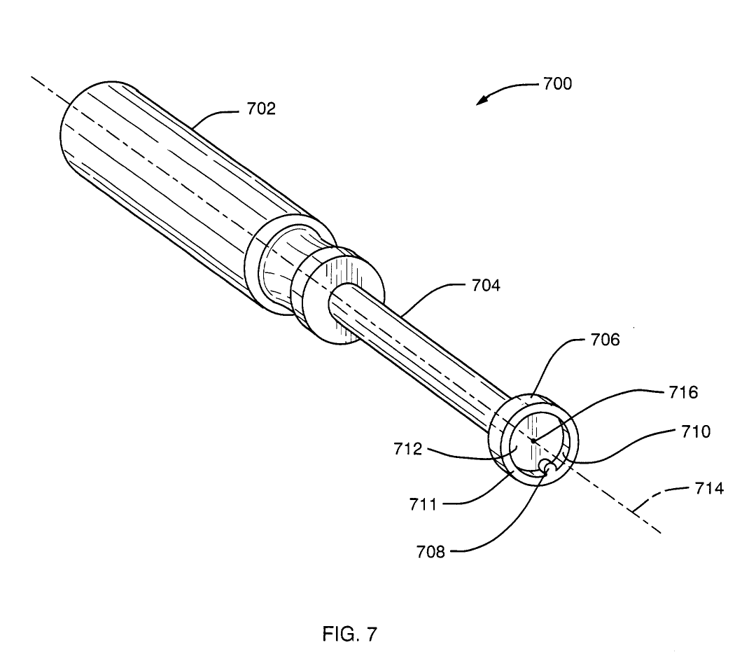

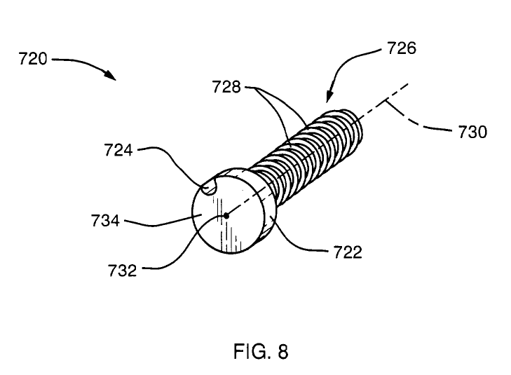

Referring to FIG. 7, a single-pin screwdriver 700 is shown according to one embodiment of the present invention. Like the screwdriver 400 illustrated in FIG. 4, the screwdriver 700 includes a generally cylindrical grip 702, a cylindrical shank 704, and a head 706. A guide-skirt 711 on the head 706 has an inner surface 710 which defines a depression for engaging a corresponding screw (see FIG. 8, below). As with screwdriver 400, central axis 714 intersects surface 712 at the center 716 of surface 712. A single non-axial pin 708 extends from forward surface 712 of head 706. Pin 708 is offset from center 716 by a distance which may be freely chosen.

Unlike pin 408, which is free-standing, pin 708 abuts inner surface 710 and may even be molded integrally with inner surface 710 so that pin 708 effectively forms a protuberance extending from inner surface 710. If, however, screwdriver 700 is implemented without the guide-skirt 711, the pin 708 may be implemented as a free-standing pin having a circular or semi-circular cross-section.

Referring to FIG. 8, a single-bore screw 720 is shown for use in conjunction with the screwdriver 700 according to one embodiment of the present invention. The screw 720 includes a generally flat and round head 722 at the end of a shank 726. The screw 720 includes a single semi-circular notch 724 extending from the outer edge of forward surface 434 of head 422. Central axis 730 intersects surface 734 at the center 732 of surface 734. Although bore 724 is semi-circular in shape, it is defined in cross-section by a circle which is offset from center 732 by a distance which is equal to the distance of pin 708 from the center 716 of the forward surface 712 of the screwdriver 700 (FIG. 7).

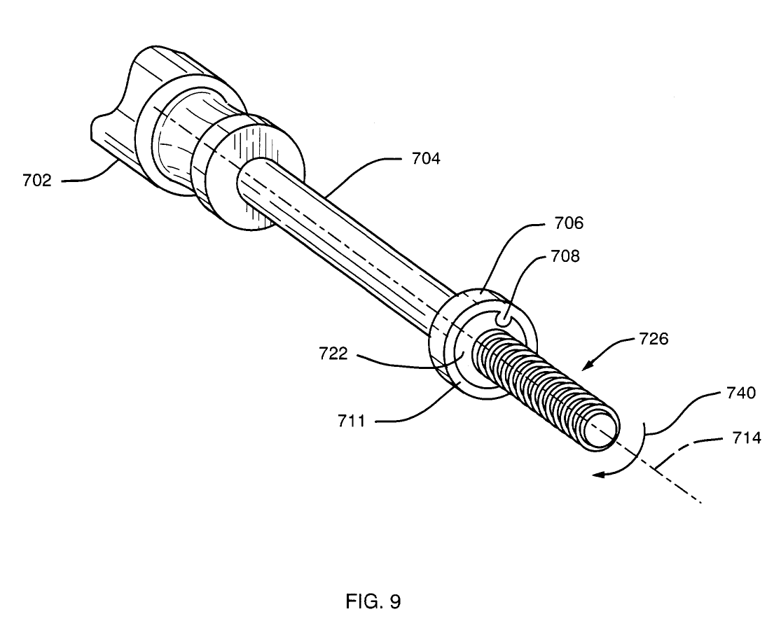

Referring to FIG. 9, the screwdriver 700 of FIG. 7 is shown in engagement with the screw 720 of FIG. 8 according to one embodiment of the present invention. The use of the screwdriver 700 to drive the screw 720 may be understood by reference to the description above with respect to FIG. 6.

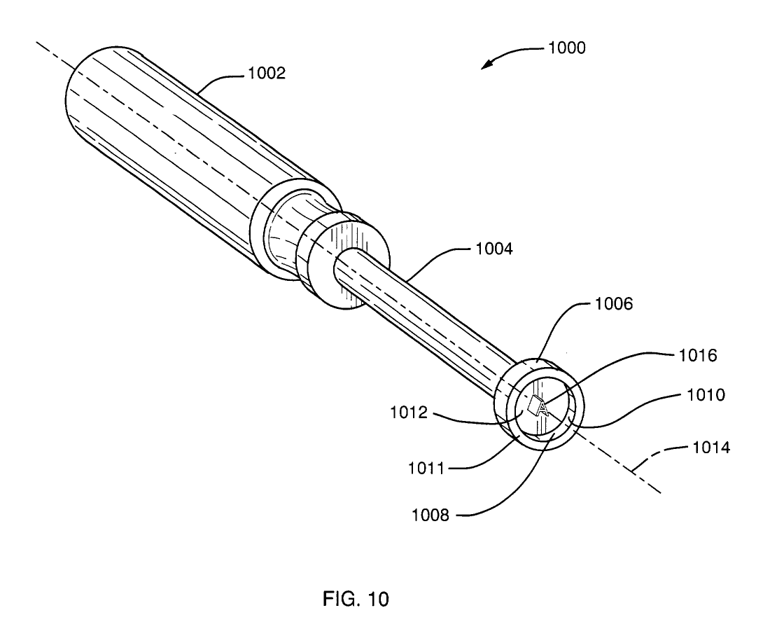

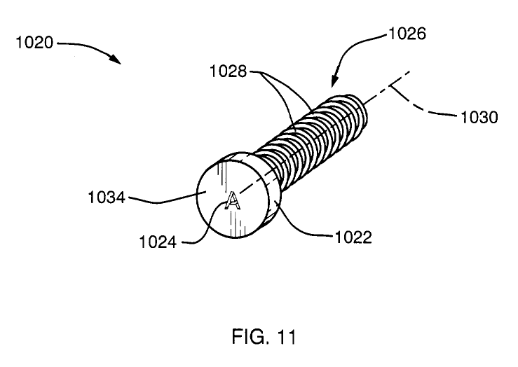

Referring to FIG. 10, a single-pin screwdriver 1000 is shown according to one embodiment of the present invention. Like the screwdriver 400 illustrated in FIG. 4, the screwdriver 1000 includes a generally cylindrical grip 1002, a cylindrical shank 1004, and a head 1006. An optional guide-skirt 1011 on the head 1006 has an inner surface 1010 which defines a depression for engaging a corresponding screw (see FIG. 11, below). A single pin 1008 extends from forward surface 1012 of head 1006. As with screwdriver 400, central axis 1014 intersects surface 1012 at the center 1016 of surface 1012. Pin 1008 is located centrally on the axis 1014. Alternatively, pin 1008 may be offset from center 1016 by a distance which may be freely chosen.

In the example illustrated in FIG. 10, the cross-section of pin 1008 is in the shape of the letter “A.” The pin 1008 may, however, have any shape, such as a letter of the alphabet, a heart shape, or a corporate logo. As illustrated below with respect to FIG. 11, the pin 1008 is shaped to engage a screw including a depression having a shape corresponding to the shape of the pin 1008.

Referring to FIG. 11, a single-bore screw 1020 is shown for use in conjunction with the screwdriver 1000 according to one embodiment of the present invention. The screw 1020 includes a generally flat and round head 1022 at the end of a shank 1026. The screw 1020 includes a single centrally-located depression 1024 extending into head 1022 from forward surface 1034 of head 1022. Central axis 1030 intersects surface 1034 at the center 1032 of surface 1034.

In the example illustrated in FIG. 11, the depression 1024 is in the shape of the letter “A,” thereby to engage the pin 1008 of the screwdriver 1000. The depression 1024, however, may have any shape, such as a letter of the alphabet, a heart shape, or a corporate logo. More generally, the depression 1024 may be in the shape of a silhouette of an image desirable for aesthetic reasons. Note that the depression 1024 may, for example, be so far offset from the central axis 1014 that the letter “A” is effectively cropped by the outer edge of the head 1022, resulting in a bore (and corresponding pin) whose shape is that portion of the letter “A” which falls within the boundary defined by the outer edge of the head 1022.

Although the depression 1024 illustrated in FIG. 11 extends only partway through the head 1022 of the screw 1020, the depression 1024 may extend fully through the screw 1020, in which case the depression 1024 is a bore. Furthermore, the depression 1024 need not be centrally located. Rather, the depression 1024 (and the corresponding pin 1008) may be offset from the center 1032 by a distance which may be freely chosen.

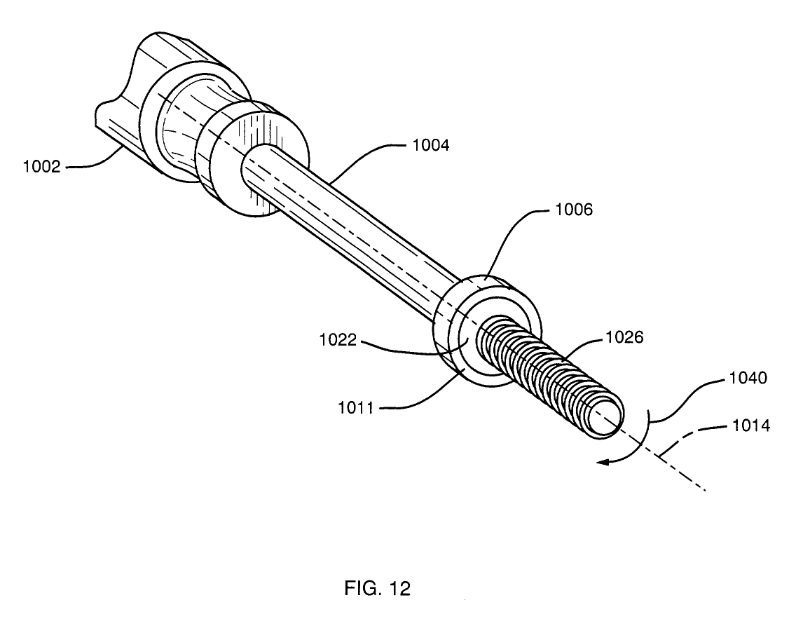

Referring to FIG. 12, the screwdriver 1000 of FIG. 10 is shown in engagement with the screw 1020 of FIG. 11 according to one embodiment of the present invention. When the pin 1008 and depression 1024 are not centrally located, the use of the screwdriver 1000 to drive the screw 1020 may be understood by reference to the description above with respect to FIG. 6. When the pin 1008 and depression 1024 are centrally located, as illustrated in FIGS. 10-12, the torque is transferred through the head 1006 to the inner surfaces of depression 1024, thereby causing the screw 420 to rotate and be driven through a material (not shown). When the pin 1008 and depression 1024 are centrally located, and assuming that the center of torque of the driving pattern is concentric with the central axis of the screw, then the guide skirt 1011, while possibly desirable in some cases for ease of alignment, etc., is not necessary since the torque is conveyed entirely by the driving pattern.

The embodiments illustrated in FIGS. 4-12 above are illustrative only and do not constitute limitations of the present invention. Rather, various other embodiments fall within the scope of the claims below. For example, the cross-sections of pin 408 and bore 424 need not be circular, but rather may be any shape, such as a triangle, square, rectangle, arc, or heart.

Similarly, the cross-sections of pin 708 and notch 724 need not be circular sections, but rather may be any shape, such as a rectangle, “V,” or oval. Other cross-sectional shapes that may be used include, but are not limited to, the following: clovers, spades, diamonds, hearts, clubs, fleur d'alis, musical notes or instruments, depictions of the moon (e.g., half-moons or quarter-moons) or sun, leaves (such as maple leaves or oak leaves), flags, portraits, flowers or other plants, animals, machinery or components thereof, seashells, snowflakes, sports equipment, geographical features (such as outlines of countries, states), stars, letters or words in any language, alchemical symbols representing elements from the periodic table, signs of the zodiac, traffic sign shapes (e.g., one way, U-turn, caution), emoticons (e.g., happy face, sad face, mad face), mathematical symbols, ideographs, and any combination thereof. Furthermore, the pins 408 and 708, bore 424, and notch 724 may be any size.

In the following discussion, references to the pin 408 may also be applicable to the other pins and heads disclosed herein (such as those illustrated in FIGS. 7-12), and any references to the bore 424 may also be applicable to the bores, notches, and depressions disclosed herein (such as those illustrated in FIGS. 7-12). The pin 408 and bore 424 may be any distance from the center points 416 and 432, respectively. The present invention is not limited to screws and screwdrivers having the numbers of pins/bores shown in FIGS. 4-12. Furthermore, the present invention is not limited to screws and screwdrivers having pins/bores arranged in the particular spatial configurations shown in FIGS. 4-12.

For example, a screw may include both a plurality of bores arranged symmetrically about the central axis of the screw head and one or more additional bores which are not symmetrically arranged about the central axis. Alternatively, the screw may include a centrally-located (circular or non-circular) bore in addition to one or more non-centrally located (and optionally non-symmetrical) bores. Alternatively, the screw may include a set of three or more (circular or non-circular) bores arranged symmetrically about the central axis. Alternatively, for example, there may be three pins in a “Y” or “V” configuration or four pins in a rectangular configuration, with bores in a corresponding configuration.

There may be fewer pins on the screwdriver 400 than bores on the screw 420. For example, there may be one pin and three bores, thereby obtaining the advantages of the screwdriver 400 and screw 420 illustrated in FIGS. 4 and 5, respectively, with the additional advantage of facilitating the engagement of the screwdriver 400 in the screw 420. A single screwdriver 400 may therefore be used with screws having different numbers of bores in different configurations, so long as a subset of the bores on each screw are located to allow engagement with the screwdriver pin(s).

The screwdriver 400 may be implemented with a head having a flat forward surface rather than the guide-skirt 411 illustrated in FIG. 4. Although the pin 408 and bore 424 illustrated in FIGS. 4 and 5, respectively, are cylindrical, the pin(s) and bore(s) may be any shape. Furthermore, a single screwdriver may include pins of varying shape. A single screw may include both bores and notches in any combination and configuration.

The bore 424 need not fully extend through the screw head 422. The pin 408 may be longer or shorter than the corresponding bore. For example, a pin that is longer than the bore through which it extends may provide extra stability and therefore eliminate or reduce the need for the guide-skirt 411. Such an extended pin may, for example, extend into the shank 426 of the screw 420. The pin 408 need not be fixed in location or length. For example, the pin 408 may be partially or entirely retractable. Examples of centrally-located retractable pins are disclosed in U.S. Pat. No. 4,314,489 to Arcangeli, entitled “Screwdrivers,” issued on Feb. 9, 1982.

It should be appreciated that each screw feature described above implicitly define complementary screwdrivers and vice versa.

Among the advantages of the invention are one or more of the following.

The non-central location of the pin 408 and bore 424 allow torque to be transferred from the screwdriver 400 to the screw 420 using a single pin/bore combination. One advantage of using a single pin/bore combination is that it may simplify and reduce the cost of designing and/or manufacturing the screwdriver 400 and screw 420. Another advantage of the screws and screwdrivers disclosed herein, which is particularly applicable to coarsely threaded screws, is that the screw can be engaged in an exactly known rotational phase of the screwdriver, a property that is not shared by conventional screwdrivers that have 2-fold (slot), 3-fold, 4-fold (Robertson), 5-fold (Allen), or 6-fold (Allen) rotational symmetries.

A further advantage of using a single pin/bore combination is that the screw 420, once driven into the desired material, presents a surface (i.e., forward surface 434) exposing the single bore 424. One or more screws exposing such surfaces may present a more aesthetically pleasing facade than screws having slotted surfaces or surfaces having dual opposing bores. Furthermore, as described above, screws with various numbers of bores having various shapes and arranged in various configurations may be implemented in accordance with the present invention, thereby presenting further opportunities for increasing the aesthetic appeal of the surface on which the screws are exposed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

What is claimed is:

1. A screw comprising:
a threaded shank having a lengthwise central axis;
a head coupled to one end of the shank, the head comprising:
a forward surface; and
a single bore, the single bore defining a region forming a gap in the forward surface, the centroid of the region being located a non-zero distance from the central axis.

2. The screw of claim 1, wherein the central axis does not intersect the region.

3. The screw of claim 1, wherein the centroid of the region is located a non-zero distance from the centroid of the forward surface.

4. The screw of claim 1, wherein a cross-section of the single bore is circular.

5. The screw of claim 4, wherein the region is circular.

6. The screw of claim 1, wherein the region intersects an edge of the forward surface.

7. The screw of claim 1, wherein the single bore extends fully through the head.

8. The screw of claim 7, wherein the single bore extends fully through the screw.

9. A screwdriver comprising:
a grip;
a shank coupled at one end to the grip and having a first lengthwise central axis; and
a single pin coupled to the other end of the shank and having a second lengthwise central axis, wherein the first and second lengthwise central axes are not coincident.

10. The screwdriver of claim 9, further comprising:
a head coupled at a first end to the other end of the shank and at a second end to the single pin.

11. The screwdriver of claim 10, wherein the head comprises a guide-skirt having an inner surface defining a depression in the head, and wherein the single pin extends outward from the depression.

12. The screwdriver of claim 11, wherein the pin comprises a protuberance on the inner surface.

13. The screwdriver of claim 9, wherein the first central axis does not intersect any portion of the single pin.

14. The screwdriver of claim 9, wherein a cross-section of the single pin is circular.

15. The screwdriver of claim 9, wherein the pin abuts an outer edge of the head.

16. The screwdriver of claim 9, wherein the pin is retractable into the shank.

17. A system comprising:
a screw comprising:
a threaded shank having a first lengthwise central axis; and
a head coupled to one end of the shank, the head comprising a forward surface and a plurality of bores, the plurality of bores defining a plurality of regions forming a plurality of gaps in the forward surface, the centroids of the plurality of regions being located non-zero distances from the first central axis; and
a screwdriver comprising:
a grip;
a shank coupled at one end to the grip and having a second lengthwise central axis; and
at least one pin coupled to the other end of the shank and having at least one third lengthwise central axis, wherein the second central axis and the at least one third lengthwise central axis are not coincident.

18. The system of claim 17, wherein the at least one pin comprises a plurality of pins.

19. The system of claim 18, wherein the plurality of pins are located asymmetrically about the second central axis.

20. The system of claim 17, wherein the distance from the second central axis to the at least one third central axis is equal to the distance from the centroid of each of the plurality of regions to the point of intersection of the first central axis and the forward surface.

21. The system of claim 17, wherein the length of at least one of the plurality of bores differs from the length of at least one of the at least one pin.

22. The system of claim 17, wherein at least one of the plurality of bores is longer than at least one of the at least one pin.

23. The system of claim 17, wherein at least one of the at least one pin is longer than at least one of the plurality of bores.

24. The system of claim 17, wherein the at least one pin comprises x pins, wherein the plurality of bores comprises y bores, and wherein x is less than y.

25. The system of claim 17, wherein the centroids of the plurality of regions are located asymmetrically about the first central axis.

26. A screw comprising:
a threaded shank having a lengthwise central axis;
a head coupled to one end of the shank, the head comprising a forward surface and at least two bores, the at least two bores defining at least two regions forming at least two gaps in the forward surface, the centroids of the at least two regions being located asymmetrically about the central axis.

27. The screw of claim 26, wherein none of the at least two regions intersects the central axis.

28. The screw of claim 26, wherein the centroids of the at least two regions are located non-zero distances from the centroid of the forward surface.

29. The screw of claim 26, wherein a cross-section of at least one of the at least two bores is circular.

30. The screw of claim 29, wherein at least one of the at least two regions is circular.

31. The screw of claim 29, wherein at least two cross-sections of the at least two regions differ in shape from each other.

32. The screw of claim 26, wherein at least one of the at least two regions intersects an edge of the forward surface.

33. The screw of claim 32, wherein at least one of the at least two regions does not intersect the edge of the forward surface.

34. The screw of claim 26, wherein at least one of the at least two bores extends fully through the head.

35. The screw of claim 34, wherein the at least one of the at least two bores extends fully through the screw.

36. The screw of claim 26, wherein the at least two bores consists of two bores.

37. The screw of claim 26, wherein the at least two bores consists of three bores.

38. The screw of claim 26, wherein the distance from the centroid of the forward surface to the centroid of a first one of the at least two bores differs from the distance from the centroid of the forward surface to the centroid of a second one of the at least two bores.

39. The screw of claim 26, wherein the head further comprises a bore having a centroid that is coincident with the central axis.

40. The screw of claim 26, wherein the head further comprises a plurality of bores, the plurality of bores defining a plurality of regions forming a plurality of gaps in the forward surface, the centroids of the plurality of regions being located symmetrically about the central axis.

41. A screwdriver comprising:
a grip;
a shank coupled at one end to the grip and having a first lengthwise central axis; and
at least two pins coupled to the other end of the shank and having at least two second lengthwise central axes, the at least two pins being located asymmetrically about the first lengthwise central axis.

42. The screwdriver of claim 41, further comprising:
a head coupled at a first end to the other end of the shank and at a second end to the at least two pins.

43. The screwdriver of claim 42, wherein the head comprises a guide-skirt having an inner surface defining a depression in the head, and wherein the at least two pins extend outward from the depression.

44. The screwdriver of claim 43, wherein at least one of the at least two pins comprises a protuberance on the inner surface.

45. The screwdriver of claim 41, wherein the first central axis does not intersect any portion of any of the at least two pins.

46. The screwdriver of claim 41, wherein a cross-section of at least one of the at least two pins is circular.

47. The screwdriver of claim 41, wherein the at least two pins abut an outer edge of the head.

48. The screwdriver of claim 41, wherein at least one of the at least two pins is retractable into the shank.

49. The screwdriver of claim 41, further comprising a pin located having a central axis coincident with the first lengthwise central axis.

50. The screwdriver of claim 41, further comprising a plurality of pins located symmetrically about the first lengthwise central axis.

51. A screw comprising:
a threaded shank having a lengthwise central axis;
a head coupled to one end of the shank, the head comprising a forward surface and at least one bore, the at least one bore defining at least one region forming at least one gap in the forward surface, the at least one region having an outline that is not a regular polygon.

52. The screw of claim 51, wherein the outline of the region comprises an outline of a letter of an alphabet.

53. The screw of claim 51, wherein the outline of the region comprises an outline of at least one shape selected from a group of shapes comprising: clovers, spades, diamonds, hearts, clubs, fleur d'alis, musical notes, musical instruments, moons, suns, leaves, flags, portraits, plants, animals, machinery, seashells, snowflakes, sports equipment, geographical features, stars, letters, alchemical symbols, signs of the zodiac, emoticons, mathematical symbols, and ideographs.

54. The screw of claim 51, wherein the at least one bore is a single bore.

55. The screw of claim 54, wherein the central axis intersects the centroid of the at least one region.

56. The screw of claim 51, wherein the at least one bore comprises a plurality of bores.

57. The screw of claim 56, wherein the at least one region comprises a plurality of regions, and wherein the centroid of at least one of the plurality of regions is located a non-zero distance from the central axis.

58. The screw of claim 57, wherein each of the plurality of regions is located a non-zero distance from the central axis.

59. The screw of claim 57, wherein the centroids of the plurality of regions are located asymmetrically about the central axis.

60. The screw of claim 51, wherein a cross-section of at least one of the at least one bore is circular.

61. The screw of claim 60, wherein at least one of the at least one region is circular.

62. The screw of claim 60, the at least one bore comprises a plurality of bores, wherein the at least one region comprises a plurality of regions, and wherein at least two cross-sections of the plurality of regions differ in shape from each other.

63. The screw of claim 51, wherein the at least one region intersects an edge of the forward surface.

64. A screwdriver comprising:
a grip,
a shank coupled at one end to the grip and having a first lengthwise central axis; and
at least one pin coupled to the other end of the shank and having at least one second lengthwise central axis, the pin comprising a pin head having an outline that is not a regular polygon.

65. The screwdriver of claim 64, wherein the first central axis is not coincident with any of the at least one central axis.

66. The screwdriver of claim 64, wherein the first central axis is coincident with at least one of the at least one central axis.

67. The screwdriver of claim 64, further comprising:
a head coupled at a first end to the other end of the shank and at a second end to the at least one pin.

68. The screwdriver of claim 65, wherein the head comprises a guide-skirt having an inner surface defining a depression in the head, and wherein the at least one pin extends outward from the depression.

69. The screwdriver of claim 68, wherein the at least one pin comprises at least one protuberance on the inner surface.

70. The screwdriver of claim 64, wherein a cross-section of at least one of the at least one pin is circular.

71. The screwdriver of claim 64, wherein the at least one pin abuts an outer edge of the head.

72. The screwdriver of claim 64, wherein at least one of the at least one pin is retractable into the shank.

73. A screw comprising:
a threaded shank having a lengthwise central axis;
a head coupled to one end of the shank, the head comprising a forward surface and at least three bores, the at least three bores defining at least three regions forming at least three gaps in the forward surface, the centroids of the at least three regions being located symmetrically about the central axis.

74. The screw of claim 73, wherein none of the at least two regions intersects the central axis.

75. The screw of claim 73, wherein a cross-section of at least one of the at least three bores is circular.

76. The screw of claim 75, wherein at least one of the at least three regions is circular.

77. The screw of claim 75, wherein at least two cross-sections of the at least three regions differ in shape from each other.

78. The screw of claim 73, wherein at least one of the at least three regions intersects an edge of the forward surface.

79. The screw of claim 78, wherein at least one of the at least three regions does not intersect the edge of the forward surface.

80. The screw of claim 73, wherein at least one of the at least three bores extends fully through the head.

81. The screw of claim 80, wherein the at least one of the at least three bores extends fully through the screw.

82. A screwdriver comprising:
a grip;
a shank coupled at one end to the grip and having a first lengthwise central axis; and
at least three pins coupled to the other end of the shank and having at least three second lengthwise central axes, the at least three pins being located symmetrically about the first lengthwise central axis.

83. The screwdriver of claim 82, further comprising:
a head coupled at a first end to the other end of the shank and at a second end to the at least three pins.

84. The screwdriver of claim 83, wherein the head comprises a guide-skirt having an inner surface defining a depression in the head, and wherein the at least three pins extend outward from the depression.

85. The screwdriver of claim 84, wherein at least one of the at least three pins comprises a protuberance on the inner surface.

86. The screwdriver of claim 82, wherein the first central axis does not intersect any portion of any of the at least three pins.

87. The screwdriver of claim 82, wherein a cross-section of at least one of the at least three pins is circular.

88. The screwdriver of claim 82, wherein the at least three pins abut an outer edge of the head.

89. The screwdriver of claim 82, wherein at least one of the at least three pins is retractable into the shank.
